(19) United States
(12) Patent Application Publication
(10) Pub. No.: US 2018/0167701 A1
(43) Pub. Date: Jun. 14, 2018

(54) POWER DETECTION DEVICE FOR BICYCLE

(71) Applicant: TIEN HSIN INDUSTRIES CO., LTD., Taichung City (TW)

(72) Inventor: YU-WEI CHANG, TAICHUNG CITY (TW)

(73) Assignee: TIEN HSIN INDUSTRIES CO., LTD., Taichung City (TW)

(21) Appl. No.: 15/377,007

(22) Filed: Dec. 13, 2016

(51) Int. Cl. H04Q 9/00; G01L 1/22; B62M 9/128; A63B 24/00

(52) U.S. Cl. CPC H04Q 9/00; G01L 1/2206; B62M 9/128; A63B 2225/50; H04Q 2209/40; H04Q 2209/88; A63B 2220/833; A63B 24/0062

(57) ABSTRACT

A power detection device for bicycles is disclosed, which comprises at least one sprocket, a sprocket base, a strain gauge, a signal processing circuit, and a wireless signal transmitting circuit, wherein the sprocket base is engaged with the sprocket, and the strain gauge is embedded in the sprocket base. The signal processing circuit is electrically connected to the strain gauge, and the wireless signal transmitting circuit is electrically connected to the signal processing circuit. The wireless signal transmitting circuit receives an electrical signal outputted by the signal processing circuit, converts it into a wireless signal, and then sends out the wireless signal. Whereby, the strain gauge can be hidden and effectively secured.

### BACKGROUND OF THE INVENTION

### 1. Technical Field

The present invention relates generally to power detection of bicycles, and more particularly to a power detection device for bicycles.

### 2. Description of Related Art

With the prevalence of leisure activities of cycling, bicycles have become a tool for leisure sports and not simply a transportation tool anymore. Therefore, a wide variety of bicycle accessories is developed in response to the trend. In order to understand the performance of cycling, bicycle computers are commonly mounted on bicycles to serve as the basis of the training. More advanced users may also install a power meter on their bicycles to check the pedaling strength at any moment or the overall riding condition.

The strain gauge of a conventional power meter is applied to an existing component of a bicycle, (e.g., mounting the strain gauge on the crank). However, the external power meter makes the appearance of the bicycle look more complicated. Furthermore, the strain gauge may be partially disengaged from the component of the bicycle (the crank, for example), and therefore cannot stably detect the deformation of the engaged component. As a result, the detection result of the strain gauge may be not accurate, so as to affect the power represented by the power meter.

### BRIEF SUMMARY OF THE INVENTION

In view of the above, the primary objective of the present invention is to provide a power detection device, of which the strain gauge could be secured and hidden.

The present invention provides a power detection device for a bicycle, wherein the power detection device is engaged with a rear hub of the bicycle. The power detection device includes at least one sprocket, a sprocket base, a strain gauge, a signal processing circuit, and a wireless signal transmitting circuit. Each of the at least one sprocket has a plurality of connection arms. The sprocket base is engaged with the sprocket to at least partially cover the connection arms. The strain gauge is embedded in the sprocket base. The signal processing circuit is electrically connected to the strain gauge, wherein the signal processing circuit is adapted to output an electrical signal according to an amount of deformation of the strain gauge. The wireless signal transmitting circuit is electrically connected to the signal processing circuit, wherein the wireless signal transmitting circuit receives the electrical signal outputted by the signal processing circuit, converts the received electrical signal into a wireless signal, and then sends out the wireless signal.

By using the strain gauge embedded in the sprocket base, the amount of deformation of the sprocket base could be accurately detected, so that the detected power would be more accurate. In addition, the strain gauge could be prevented from falling off from the sprocket base, and could be hidden therein. In other words, the user would not see the strain gauge from outside.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first embodiment of the present invention;

FIG. 2 is a perspective exploded view of the first embodiment of the present invention;

FIG. 3 is a block view of the detection module of the first embodiment of the present invention;

FIG. 4 is a block view of the detection module of a second embodiment of the present invention;

FIG. 5 is a block view of the detection module of a third embodiment of the present invention;

FIG. 6 is a block view of the detection module of a fourth embodiment of the present invention;

FIG. 7 is a block view of the detection module of a fifth embodiment of the present invention;

FIG. 8 is a block view of the detection module of a sixth embodiment of the present invention; and

FIG. 9 is a block view of the detection module of a seventh embodiment of the present invention.

### DETAILED DESCRIPTION OF THE INVENTION

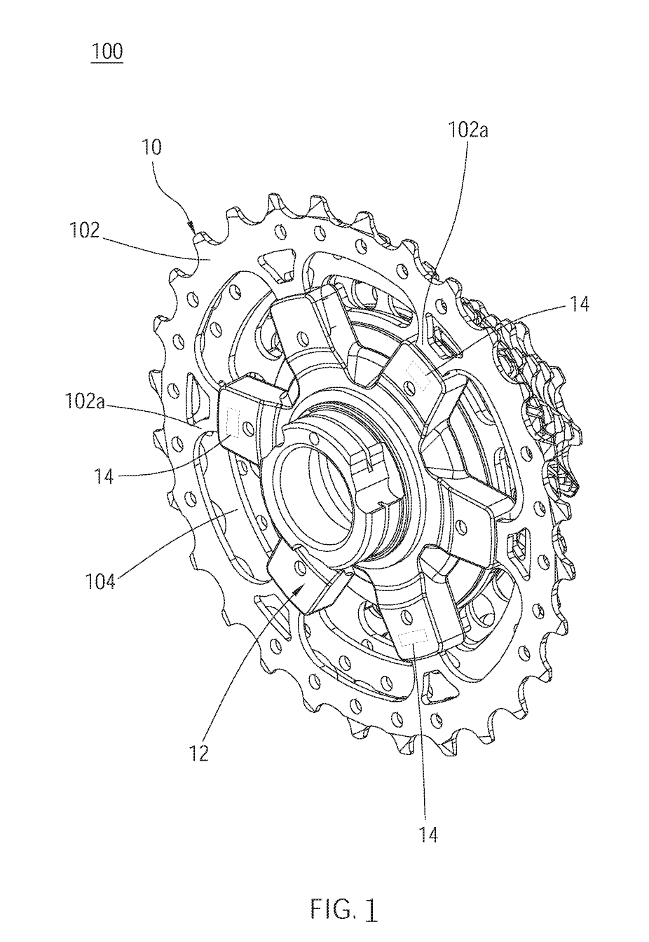

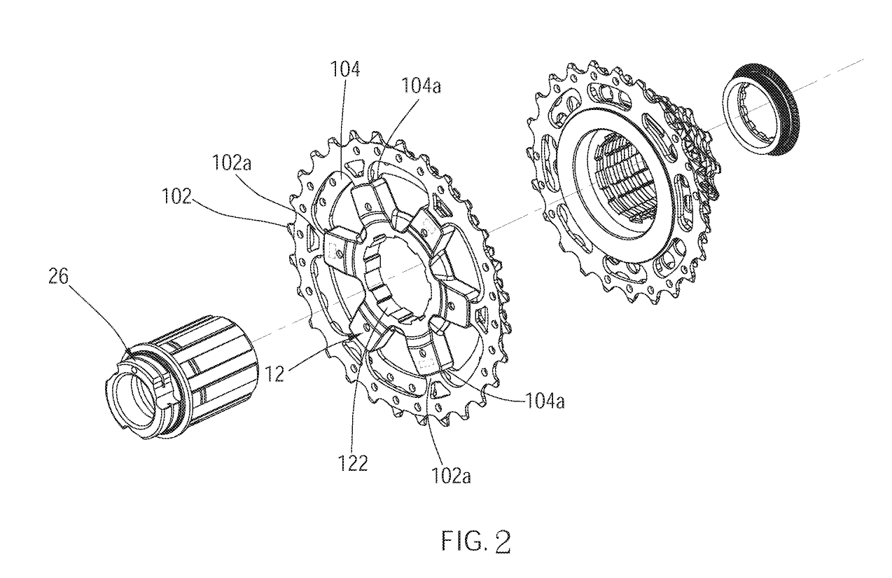

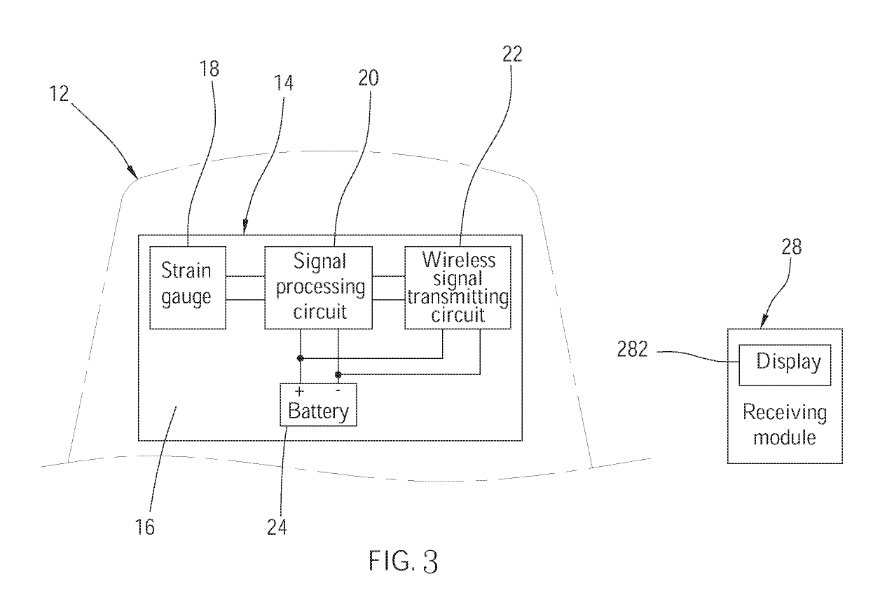

As shown in FIG. 1 to FIG. 3, a power detection device 100 of a first embodiment of the present invention is coupled to a sleeve 26 of a rear hub of a bicycle, wherein the power detection apparatus 100 includes at least one sprocket 10, a sprocket base 12, and a plurality of the detection modules 14.

The at least one sprocket 10 includes more than one sprocket 10 in the first embodiment, which are a first sprocket 102 and a second sprocket 104. The first sprocket 102 and the second sprocket 104 each has a plurality of connection arms 102a, 104a in an inner ring thereof. An outer diameter of the first sprocket 102 is greater than an outer diameter of the second sprocket 104, and the first sprocket 102 has more teeth than the second sprocket 104. In practice, the number of the at least one sprocket 10 could be more than two.

The sprocket base 12 is coupled to the first sprocket 102 and the second sprocket 104, wherein at least a portion of the connection arms 102a, 104a or the first sprocket 102 and the second sprocket 104 are coated by the sprocket base 12. An assembly hole 122 is provided at a center of the sprocket base 12, wherein the assembly hole 122 is adapted to fit around the sleeve. In the first embodiment, the sprocket base 12 is formed by placing the connected first sprocket 102 and second sprocket 104 in a mold (not shown), and injecting a plastic material (e.g., fiber-reinforced plastic) into the mold.

In addition, in the first embodiment, the detection modules 14 are placed in the mold together during the forming operation of the sprocket base 12, and are located at positions corresponding to the connection arms 102a, 104a. After that, the detection modules 14 are coated by the injected plastic, and therefore are embedded in the sprocket base 12 near the connection arms 102a, 104a. However, it must be noted that, since the detection modules 14 all have the same structure, one of the detection modules 14 is taken as an example in the following paragraphs.

Said detection module 14 includes a circuit board 16, a strain gauge 18 disposed on the circuit board 16, a signal processing circuit 20, a wireless signal transmitting circuit 22, and a power supply which is a battery 24 as an example, wherein the strain gauge 18 deforms along with the force exerted on the sprocket base 12. The signal processing circuit 20 is electrically connected to the strain gauge 18 and the wireless signal transmitting circuit 22, wherein the signal processing circuit 20 outputs an electrical signal according to an amount of deformation of the strain gauge 18. The wireless signal transmitting circuit 22 receives the electrical signal outputted by the signal processing circuit 20, converts it into a wireless signal, and then transmits the wireless signal to a receiving module 28 which is located outside. In this way, a display 282 of the receiving module 28 could correspondingly display the power detected by the strain gauge 18 for user's reference. The battery 24 is electrically connected to the signal processing circuit 20 and the wireless signal transmitting circuit 22, wherein the battery 24 is used to provide the required power to the signal processing circuit 20 and the wireless signal transmitting circuit 22.

Since the strain gauge 18, the signal processing circuit 20, the wireless signal transmitting circuit 22, and the battery 24 are firmly embedded in the sprocket base 12, the components in each of the detection modules 14 could be prevented from falling off while a rider is riding the bicycle. In addition, the strain gauge 18 is securely covered by the sprocket base 12, and therefore the strain gauge 18 could be deformed precisely in response to the force exerted on the sprocket base 12, whereby to get more accurate results for power detection.

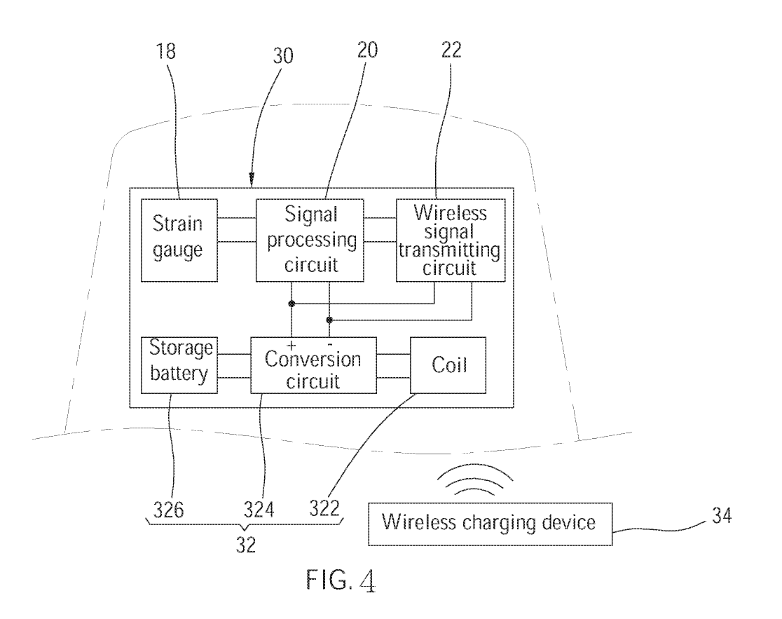

A detection module 30 of a power detection device of a second embodiment of the present invention is illustrated in FIG. 4, wherein the detection module 30 has substantially identical structure to each of the detection modules 14 of the first embodiment, except that a power supply 32 of the detection module 30 includes a coil 322, a conversion circuit 324, and a storage battery 326. The coil 322 is used for receiving power provided by an external wireless charging device 34, wherein the received power is converted into an electrical signal by the coil 322, and the electrical signal is then outputted. The conversion circuit 324 respectively electrically connects the coil 322 and the storage battery 326, whereby to convert the electrical signal outputted by the coil 322 into a direct current (DC) to charge the storage battery 326. The power of the storage battery 326 is provided to the signal processing circuit 20 and the wireless signal transmitting circuit 22 through the conversion circuit 324, whereby to supply the required power. With such design, the wireless charging device 34 could be used to charge the storage battery 326 when the bicycle is not used.

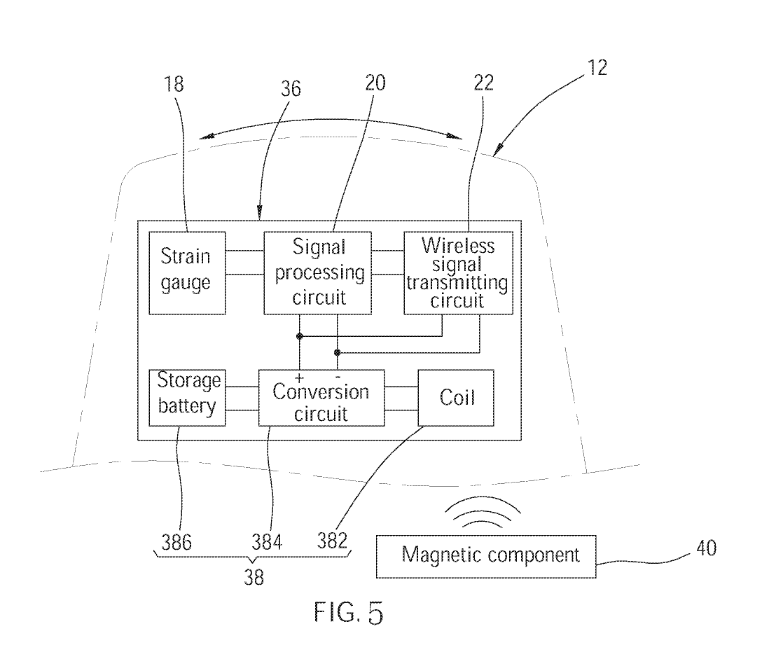

A detection module 36 of a power detection device of a third embodiment of the present invention is illustrated in FIG. 5, which has the concept of wireless charging similar to the second embodiment. A power supply 38 of the detection module 36 includes a coil 382, a conversion circuit 384, and a storage battery 386. The main difference between the second and the third embodiments is that, in the third embodiment, the storage battery 386 is charged while the sprocket base 12 is being rotated. More specifically, when the detection module 36 is driven by the sprocket base 12 to pass through a magnetic component 40, the coil 382 is affected by the energy of the magnetic component 40, which is the magnetic energy as an example. As a result, the coil 382 produces an electrical signal, which is an induced current as an example, and then outputs the electrical signal to the conversion circuit 384, wherein the conversion circuit 384 converts the induced current into direct current to charge the storage battery 386. The storage battery 386 provides the signal processing circuit 20 and the wireless signal transmitting circuit 22 the required power through the conversion circuit 384. Said magnetic component 40 could be mounted at a fixed position on a bicycle frame (not shown). Whereby, power could be continuously generated while riding the bicycle.

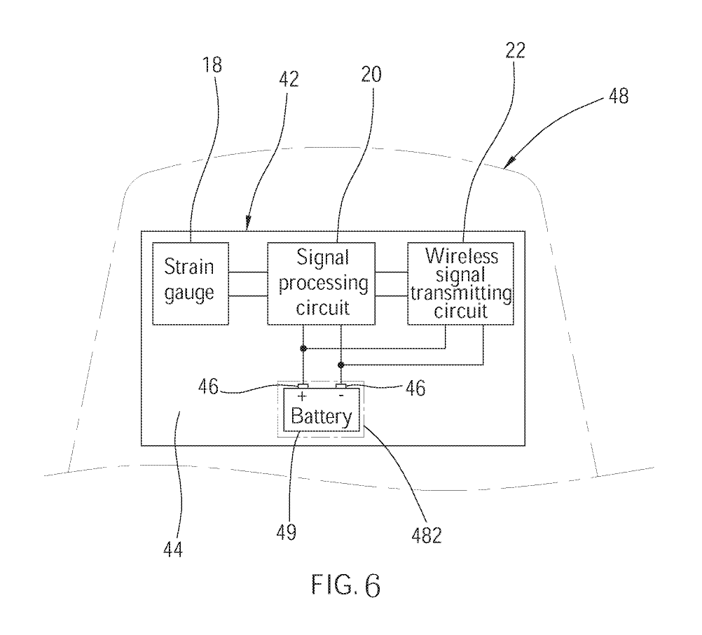

A detection module 42 of a power detection device of a fourth embodiment of the present invention is illustrated in FIG. 6, which has substantially the same structure as each of the detection modules 14 of the first embodiment, except that the power detection device of the fourth embodiment does not include a power supply, and the sprocket base 48 has a battery slot 482 communicating with the outside. The circuit board 44 has two connectors 46 provided thereon, wherein the two connectors 46 protrude into the battery slot 482, and are electrically connected to the signal processing circuit 20, and power input ports of the wireless signal transmitting circuit 22. A battery 49 of the fourth embodiment is detachably provided in the battery slot 482 to contact the connectors 46, whereby to provide the required power.

In each of the aforementioned first to fourth embodiments, the detection module is hidden in the sprocket base. Therefore, the detection module could be effectively fixed, and would be not visible from outside.

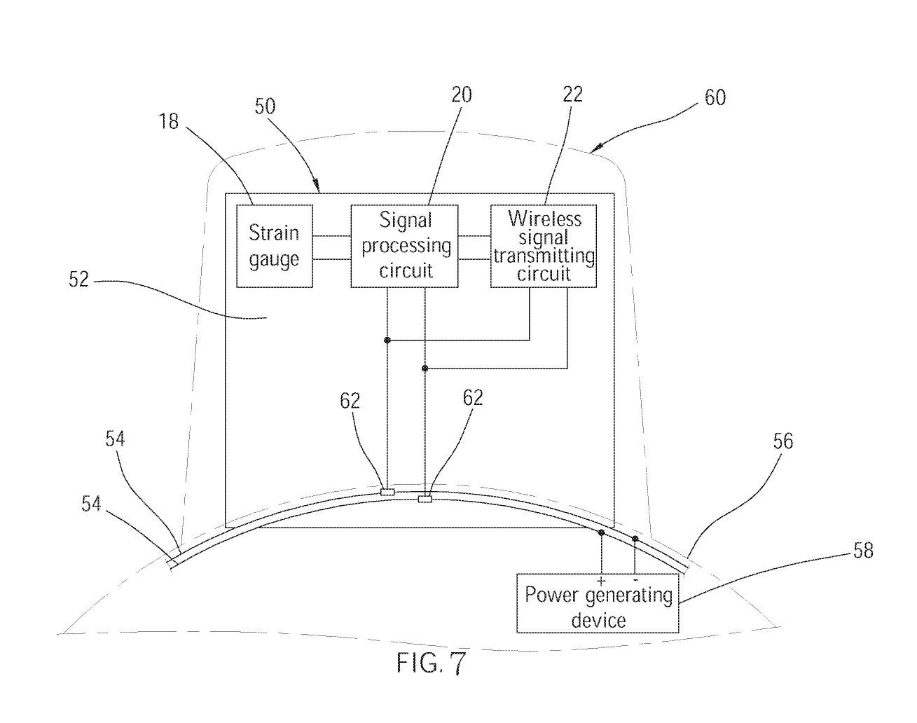

A detection module 50 of a power detection device of a fifth embodiment of the present invention is illustrated in FIG. 7, wherein the difference between the first embodiment and the fifth embodiment is that, the power detection device of the fifth embodiment does not include a power supply, and the required power is provided by a power generating device 58 provided in a rear hub 56. To meet such a requirement, the power detection device of the fifth embodiment includes two conductive portions 54, each of which is a closed ring, and is provided at the rear hub 56 to electrically connect the power generating device 58. The conductive portions 54 are rotatable along with the rear hub 56. A sprocket base 60 of the fifth embodiment has two connectors 62 provided on a surface thereof, wherein the connectors 62 are connected to the circuit board 52, and are electrically connected to the signal processing circuit 20 and the power input ports of the wireless signal transmitting circuit 22. Each of the connectors 62 respectively abuts against one of the conductive portions 54. The connectors could be driven by the sprocket base 60 to move along a circumference of the conductive portions 54 while keeping being electrically connected to the conductive portions 54. Whereby, the detection module 50 could be powered through the external power generating device 58 while a rider is riding the bicycle.

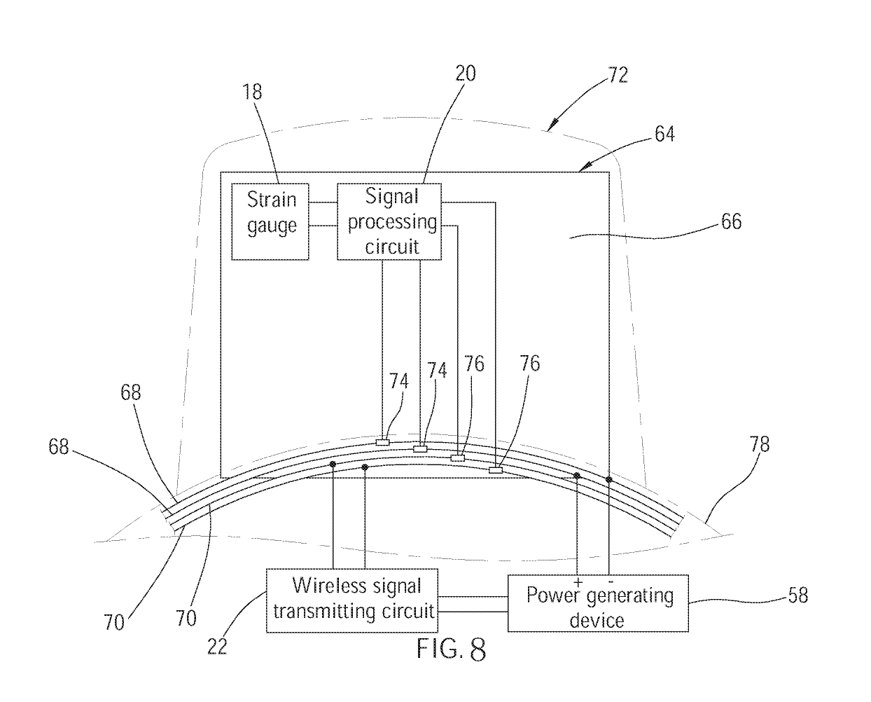

A detection module 64 of a power detection device of a sixth embodiment of the present invention is illustrated in FIG. 8, which has a substantially identical structure to the detection module 50 of the fifth embodiment, except that the wireless signal transmitting circuit 22 is provided at a rear hub 78, and the conductive portion of the power detection device is divided into a plurality of first conductive portions 68 and a plurality of second conductive portions 70, wherein the first conductive portions 68 are electrically connected to the wireless signal transmitting circuit 22, while the second conductive portions 70 are electrically connected to the power generating device 58, which is also electrically connected to the wireless signal transmitting circuit 22. The sprocket base 72 is provided with a plurality of first connectors 74 and a plurality of second connectors 76 on a surface thereof, wherein the first and the second connectors 74, 76 are engaged on the circuit board 66. Each of the first connectors 74 is electrically connected to one of output ports of the signal processing circuit 20, wherein each of the output ports is adapted to output the electrical signal of the detection result of the corresponding strain gauge 18. Each of the second connectors 76 is electrically connected to one of power input ports of the signal processing circuit 20. Each of the first connectors 74 is respectively in contact with one of the first conductive portions 68, while each of the second connectors 76 is respectively in contact with one of the second conductive portions 70. Furthermore, the first conductive portions 68 and the second conductive portions 70 are maintained as being electrically connected to the first connectors 74 and the second connectors 76 through the sprocket base 72 while the first conductive portions 68 and the second conductive portions 70 are rotated along with the rear hub 78. Whereby, the detection module 64 could be also powered by an external power supply.

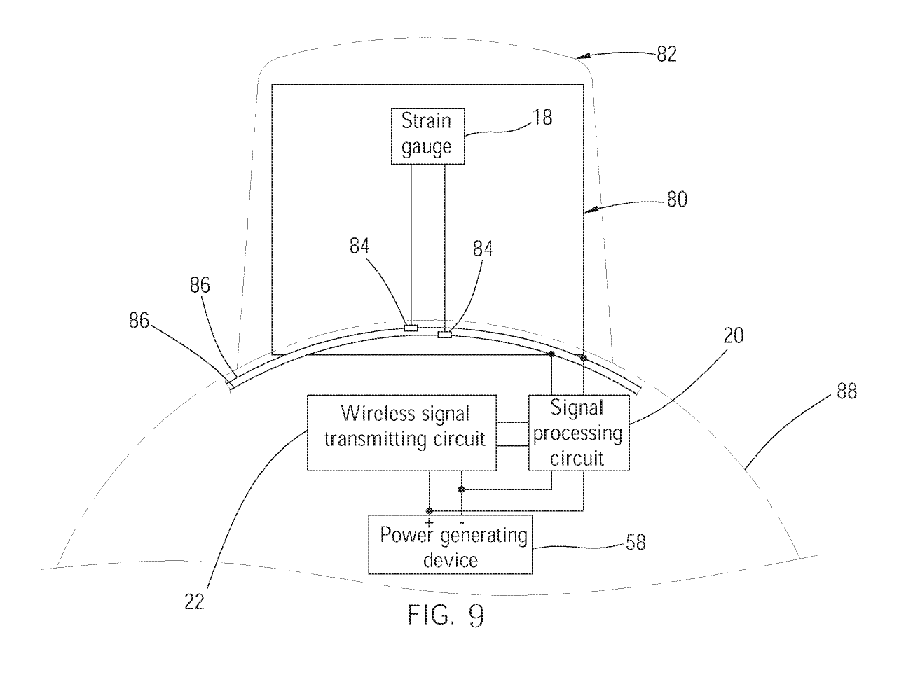

A detection module 80 of a power detection device of a seventh embodiment of the present invention is illustrated in FIG. 9, which has a substantially identical structure to the fifth embodiment, except that the signal processing circuit 20 of the seventh embodiment is disposed at the rear hub 88, and two conductive portions 86 are electrically connected to the signal processing circuit 20. In addition, two connectors 84 on a surface of a sprocket base 82 are electrically connected to the strain gauge 18. The power generating device 58 supplies power to the signal processing circuit 20 and the wireless signal transmitting circuit 22. Whereby, the strain gauge 18 could be also firmly embedded in the sprocket base 82, and the detection results could be outputted through the conductive portions 86 and the connectors 84.

With the aforementioned design that the strain gauge is embedded in a sprocket base, the strain gauge would be precisely deformed according to the force exerted on the sprocket base, whereby the detected power would be more accurate. Furthermore, the strain gauge could be effectively prevented from falling off from the sprocket base, and could be hidden therein, so that the strain gauge would not be visible from outside.

It must be pointed out that the embodiments described above are only some preferred embodiments of the present invention. All equivalent structures which employ the concepts disclosed in this specification and the appended claims should fall within the scope of the present invention.

What is claimed is:

1. A power detection device for a bicycle, wherein the power detection device is engaged with a rear hub of the bicycle; comprising:
at least one sprocket, each of which has a plurality of connection arms;
a sprocket base engaged with the sprocket to at least partially cover the connection arms;
a strain gauge embedded in the sprocket base;
a signal processing circuit electrically connected to the strain gauge, wherein the signal processing circuit is adapted to output an electrical signal according to an amount of deformation of the strain gauge; and
a wireless signal transmitting circuit electrically connected to the signal processing circuit, wherein the wireless signal transmitting circuit receives the electrical signal outputted by the signal processing circuit, converts the received electrical signal into a wireless signal, and then sends out the wireless signal.

2. The power detection device of claim 1, wherein the signal processing circuit is embedded in the sprocket base.

3. The power detection device of claim 2, further comprising a plurality of first conductive portions and a plurality of second conductive portions, wherein the first and the second conductive portions are provided at the rear hub; the wireless signal transmitting circuit is disposed at the rear hub, and is electrically connected to the first conductive portions; a plurality of first connectors and a plurality of second connectors are provided on a surface of the sprocket base; the first connectors are electrically connected to an output port of the signal processing circuit, wherein the output port is adapted to output the electrical signal corresponding to the deformation of the strain gauge; the second connectors are electrically connected to a power input port of the signal processing circuit; the first connectors are respectively in contact with the first conductive portions, while the second connectors are respectively in contact with the second conductive portions; the first conductive portions and the second conductive portions are maintained as being electrically connected to the first connectors and the second connectors through the sprocket base while the first conductive portions and the second conductive portions are rotated along with the rear hub.

4. The power detection device of claim 2, further comprising a power supply, wherein the power supply and the wireless signal transmitting circuit are embedded in the sprocket base; the power supply is electrically connected to the signal processing circuit and the wireless signal transmitting circuit to provide required power to the signal processing circuit and the wireless signal transmitting circuit.

5. The power detection device of claim 4, wherein the power supply comprises a coil, a conversion circuit, and a storage battery; the coil is adapted to receive an external energy and to convert the external energy into an electrical signal to be outputted; the conversion circuit is electrically connected to the coil and the storage battery, wherein the conversion circuit converts the electrical signal outputted by the coil into a direct current, which is outputted to the storage battery, whereby to charge the storage battery; the storage battery provides the required power to the signal processing circuit and the wireless signal transmitting circuit.

6. The power detection device of claim 1, further comprising two conductive portions provided on the rear hub, wherein the signal processing circuit and the wireless signal transmitting circuit are disposed at the rear hub; the signal processing circuit is electrically connected to the conductive portions; two connectors are provided on a surface of the sprocket base, wherein the connectors are electrically connected to the strain gauge, and are respectively in contact with the conductive portions; the connectors are maintained as being electrically connected to the conductive portions through being driven by the sprocket base.

7. The power detection device of claim 2, wherein the wireless signal sending circuit is embedded in the sprocket base.

8. The power detection device of claim 7, further comprising two conductive portions, which are disposed on the rear hub and rotatable along with the rear hub, wherein two connectors are provided on a surface of the sprocket base; the connectors are electrically connected to the signal processing circuit and the wireless signal transmitting circuit, and are respectively in contact with the conductive portions; the connectors are maintained as being electrically connected to the conductive portions through being driven by the sprocket base.

9. The power detection device of claim 7, wherein the sprocket base has a battery slot communicating with outside; the battery slot has two connectors provided therein; the connectors are electrically connected to the signal processing circuit and the wireless signal transmitting circuit.

10. The power detection device of claim 1, wherein the strain gauge is located near one of connection arms of the sprocket.
